(19) United States
(12) Patent Application Publication
(10) Pub. No.: US 2026/0350442 A1
(43) Pub. Date: Nov. 5, 2026

(54) INFLUENCE ATTRIBUTION AND PARTITIONING WITHIN A MULTI-STAGE DATA PROCESSING PIPELINE

(71) Applicant: VantageScore Solutions, LLC, San Francisco, CA (US)

(72) Inventors: Benjamin Shai Lieberman, Potomac, MD (US); Andrada Ioana Pacheco, Danbury, CT (US)

(21) Appl. No.: 19/660,742

(22) Filed: Apr. 28, 2026

Related U.S. Application Data
(60) Provisional application No. 63/798,941, filed on May 2, 2025.

(51) Int. Cl. G06N 7/01

(52) U.S. Cl. CPC G06N 7/01

(57) ABSTRACT

A system and method for attributing and partitioning influence of input variables across a multi-stage data processing pipeline. The data processing pipeline includes one or more child nodes and a parent node, each associated with explainability data quantifying the relative contribution of respective input variables to respective output values. An attribution manager traverses a directed acyclic graph representation of the data processing pipeline in reverse, from an output of the parent node through intermediate nodes to original input variables, computing contribution values along paths through the graph. For input variables consumed by child nodes, the attribution manager linearly partitions the parent-level importance of each child node's output among the child node's input variables in proportion to the explainability data associated with that child node. The resulting per-input attribution values identify the magnitude and direction of each input variable's influence on the output of the pipeline.

### CROSS-REFERENCE TO RELATED APPLICATIONS

This application is a nonprovisional of, and claims the benefit under 35 U.S.C. § 119 of, U.S. Provisional Patent Application No. 63/798,941, filed on May 2, 2025, and entitled “DECOMPOSING IMPORTANCE OF FEATURES IN A MACHINE LEARNING MODEL” the contents of which is incorporated by reference in its entirety.

### TECHNICAL FIELD

Embodiments described herein relate to multi-stage data processing systems, and, in particular, to systems and methods for attributing and partitioning influence of input variables across hierarchically structured inference pipelines.

### BACKGROUND

Multi-stage data processing pipelines, including those leveraging one or more trained machine learning models, can be configured to receive input data and to provide, as output, a score, label, classification, assessment, or other structured result that encodes higher-order information derived from that input data. In many configurations, a pipeline may include a hierarchy of models in which one or more intermediate models generate features that are thereafter consumed by a subsequent model responsible for producing a final output. Such architectures can improve predictive accuracy while supporting a modular design.

However, as the complexity and size of a data processing pipeline increases, whether through additional processing stages, additional input variables, or increasing sophistication of individual models within the pipeline, it may become progressively more difficult to determine which input variables influence the overall output and to what degree.

### SUMMARY

Embodiments described herein can take the form of a system and a method for attributing influence of input variables to output values of a multi-stage data processing pipeline.

A system as described herein includes a memory storing a graph representation of a data processing pipeline, the graph representation defining a directed acyclic graph in which a set of nodes corresponds to discrete processing stages of the data processing pipeline and directed edges between nodes of the set of nodes define dependency relationships that encode how data propagates through the data processing pipeline, at least a subset of the set of nodes being associated with explainability data that quantifies a relative contribution of respective inputs to a respective node to an output of the respective node.

The system further includes a processor communicably coupled to the memory and operable with the memory to receive a set of input values provided to the data processing pipeline, receive an output value produced by the data processing pipeline, traverse the graph representation in reverse beginning at the output value and proceeding through intermediate nodes toward the set of input values to determine a proportion of influence attributable to respective inputs of a given node, compute contribution values along paths from the output value through intermediate nodes to respective input values as products of sequential explainability proportions, combine contribution values across paths to produce attribution values, generate a ranked ordering of input variable influence, and cause to be rendered in a graphical user interface an indication of at least one input variable associated with a largest absolute value of influence selected from the ranked ordering.

Additional embodiments take the form of a system including a memory storing a graph representation of a data processing pipeline and a processor operable with the memory to determine a parent node output importance to a child node of the directed acyclic graph based on explainability data associated with the child node, retrieve parent node input importance data quantifying a relative contribution of input variables consumed by a parent node to an intermediate output of the parent node, and partition the parent node output importance across the input variables consumed by the parent node in proportion to the parent node input importance data to produce partitioned importance values. In related embodiments, the data processing pipeline may be a device health monitoring pipeline, a factory floor monitoring pipeline, a vehicle fleet management pipeline, a distributed software services monitoring pipeline, a logistics and supply chain monitoring pipeline, or a scoring pipeline in which a child node consumes intermediate metrics produced by a parent node from third-party-reported data associated with a user, and the output of the child node may be a composite score, a health metric, a label, an evaluation score, or the like.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts an example system architecture including a client device, a data processing service, an attribution manager, and associated processor and memory resources, such as described herein.

FIG. 2 depicts a functional block diagram of a data processing service including a data processing pipeline and a graph representation thereof, such as described herein.

FIG. 3A depicts a multi-model data processing pipeline including a set of input variables, one or more parent nodes, a child node, and an attribution manager, such as described herein.

FIG. 3B depicts the multi-model data processing pipeline of FIG. 3A, illustrating an attribution traversal through the parent nodes and the child node, such as described herein.

FIG. 4 depicts a data flow diagram illustrating processing of child model data and parent model data into a feature importance table, such as described herein.

FIG. 5 depicts an example graphical user interface rendering a diagnostics environment including a computed score and feature-level influence explanations, such as described herein.

FIG. 6 depicts an example graphical user interface rendering a predicted score projection over time, such as described herein.

FIG. 7 is a flowchart depicting example operations of a method for providing inputs to a multi-model data processing pipeline and traversing a graph representation thereof to determine input-level importance, such as described herein.

FIG. 8 is a flowchart depicting example operations of a method for determining parent node output importance and partitioning that importance across parent node inputs, such as described herein.

FIG. 9 is a flowchart depicting example operations of a method for determining positive and negative explainability for a given node and partitioning importance across parent node inputs, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Additionally, it should be understood that the block diagrams and system architectures presented in the accompanying figures are provided merely to facilitate an understanding of the various embodiments described herein and, accordingly, may not necessarily depict all hardware components, software instances, communication pathways, or intermediary appliances that may be present in a particular implementation. Intervening appliances or other elements, including but not limited to networking equipment, packet switching networks, routers, firewalls, load balancers, proxy servers, air gaps, encryption layers, middleware instances, message queues, or other hardware or software components, may interpose any two or more depicted elements without departing from the scope of the described or depicted embodiments. Similarly, depicted elements may be combined into fewer components, subdivided into additional components, or rearranged in any suitable configuration, and the presence or absence of any particular element in a given figure is not intended to indicate any preference or requirement for an illustrated embodiment to the exclusion of embodiments described with reference thereto.

### DETAILED DESCRIPTION

Embodiments described herein relate to systems and methods for attributing and partitioning influence of input variables across hierarchically structured inference pipelines. For example, a multi-stage inference pipeline can include multiple differently instantiated, differently trained inference instances that perform specific operations in a directed sequence (e.g., output of one or more inference stages can be provided as input to downstream, different, inference stages). In these architectures, a set of input variables may be provided as input to a first layer of inference stages, which in turn provided output to a second layer of inference and/or non-inference stages, and so on until a final output is provided. Embodiments described herein relate to systems and methods for attributing the positive, negative, and/or neutral influence of the original input variables on an outcome or output of the entire data processing pipeline.

More particularly, embodiments described herein relate to data processing systems in which a multi-stage pipeline includes one or more nodes that consume input variables and produce intermediate or final output values, and in which an influence attribution manager determines and apportions relative influence of input variables to effects on the output of the pipeline.

A "data processing pipeline" as described herein may be implemented in a number of suitable ways, with an arbitrary number of stages. For example, a data processing pipeline can include stages such as database extractions, transformations, machine inference, machine generative output, reformatting stages, recasting, and the like. As used herein, the phrase "data processing pipeline" refers to a system that receives as input digital or analog data and provides, as output other digital or analog data. A data processing pipeline as described herein may be representable as a directed acyclic graph in which edges represent input/output relationships between different nodes, which each represent at least one data transformation, inference, or generative operation.

Broadly, any node of an example data processing pipeline as described herein may be deterministic and non-inference-based, such as transformation nodes or data extraction nodes. In other cases, some nodes of a data processing pipeline may be configured for labeling input data and/or classifying input data by leveraging one or more trained neural networks, support machines, or the like. In yet other examples, one or more nodes of a data processing pipeline may be a generative output node, based on one or more large language models ("LLM"). More broadly, it may be appreciated that data processing pipelines, however implemented, can be leveraged in a number of different contexts to serve a number of purposes.

For example, an electronic device or system (e.g., personal electronic device, server, networking appliance, or the like) can include a device health monitoring system. The device health monitoring system may leverage a multi-stage data processing pipeline in which multiple independent inference models operate with respect to data generated in respect of different hardware subsystems of the electronic device.

For example, a first machine-learning model may consume thermal sensor data and voltage telemetry associated with a graphics processing unit to produce a graphics health metric. A second machine-learning model may consume clock frequency data, cache error rates, and power draw measurements to produce a processor health metric. A third machine-learning model may consume input voltage stability, ripple measurements, and load response data to produce a power supply health metric.

In this example, the health monitoring system may further include a downstream aggregation model to receive the graphics health metric, the processor health metric, and the power supply health metric as input features. This aggregation model may be configured to produce a single composite device health score. In this configuration, the data processing pipeline includes multiple chained inference stages, and the composite device health score reflects the combined operation of several upstream models.

In another example, a factory floor monitoring system may include a data processing pipeline in which sensor-level inference models produce stage-level health metrics that are thereafter consumed by further downstream models. A first inference model may process vibration, temperature, and motor current data from a stamping press to produce a stamping stage health metric. A second inference model may process optical inspection data, alignment telemetry, and conveyor speed from a quality control station to produce an inspection stage health metric. One or more additional inference models may similarly produce health metrics for other manufacturing stages. A facility-level aggregation model may thereafter consume these stage-level health metrics as input features and produce a single facility health score. As with the preceding example, the facility health score is the product of a chain of inference stages.

In a similar manner, a vehicle fleet management system may leverage a data processing pipeline in which vehicle-level inference models produce health or readiness metrics that are consumed by a fleet-level aggregation model. For a given vehicle, a first inference model may process engine telemetry, oil pressure, and exhaust composition data to produce a drivetrain health metric. A second inference model may process tire pressure, brake pad thickness, and suspension load data to produce a safety system health metric. A third inference model may process battery charge state, alternator output, and wiring harness continuity data to produce an electrical system health metric.

As with previous examples, a downstream model may thereafter consume the foregoing vehicle-level metrics to produce a composite vehicle readiness score, and a yet further downstream model may aggregate vehicle readiness scores across a fleet to produce a fleet availability metric. In this configuration, the fleet availability metric reflects the combined operation of multiple layers of inference spanning individual sensor readings through vehicle-level and fleet-level aggregation.

In yet another example, a distributed software services platform may leverage a data processing pipeline to monitor and evaluate the operational health of a large-scale application deployment. A first inference model may consume request latency, error rates, and queue depths associated with an authentication service to produce an authentication service health metric. A second inference model may consume throughput measurements, cache hit ratios, and memory utilization data associated with a data retrieval service to produce a data retrieval service health metric. Additional inference models may similarly produce health metrics for other services within the deployment. A downstream aggregation model may receive these service-level health metrics as input features and produce a composite platform health score. As with prior examples, the platform health score is derived from a chain of inference operations spanning multiple models.

In a logistics and supply chain context, a data processing pipeline may include inference models operating at different levels of a distribution network. A first inference model may process warehouse inventory levels, order fulfillment rates, and storage utilization data to produce a warehouse efficiency metric. A second inference model may process route completion times, fuel consumption, and vehicle load factors to produce a transportation efficiency metric. A third inference model may process supplier lead times, defect rates, and delivery variance data to produce a supplier reliability metric. A downstream model may thereafter consume these intermediate metrics as input features to produce a composite supply chain performance score. The composite supply chain performance score reflects the combined outputs of multiple upstream inference models operating at different levels of the distribution network.

These foregoing examples are non-limiting of the possible applications of a multi-stage inference pipeline in which different stages or nodes are implemented as discrete machine learning model instances, inference instances, generative instances, or the like. Broadly, it may be appreciated that a multi-stage inference pipeline, as the phrase is used herein, can aggregate information in a variety of contexts and for a variety of purposes. For example, in other configurations, a data processing pipeline may be configured to estimate a likelihood of default for a borrower. In this instance, a first inference model may consume payment history and account age data to produce a payment behavior metric. A second inference model may consume income verification and employment tenure data to produce a stability metric. A downstream aggregation model may receive these intermediate metrics as input features and produce a composite default risk score that in turn may be used to inform a lending decision.

Generally and broadly, these preceding examples and others related thereto illustrate that multi-stage data processing pipelines can be configured to aggregate information encoded within a large number of input variables through one or more layers of inference and/or generation to produce a high-order aggregate output, such as a composite score, a health metric, a label, an evaluation score, a probability, an assessment, a status, and/or a classification. Such architectures can be extremely effective at encoding and simplifying complex relationships among dozens or hundreds of input variables and may be likewise effective at producing simple outputs that reduce potentially overwhelming volumes of data into consumable and understandable singular metrics. In many examples, these aggregate scores can be used as a summary of a state of a large and complex system such as a fleet of vehicles, financial health of a particular customer, likelihood of a consumer to purchase a particular product or class of products, a status of a manufacturing floor or stage, a health metric in respect of a person, process, or mechanism, or the like.

However, it may be likewise appreciated that as the number of inference stages increases for a given pipeline, and as individual models within the pipeline grow in complexity, the relationship between any particular input variable and a final output of the pipeline may become increasingly opaque.

More specifically, intermediate models that produce values used by downstream models influence downstream metrics in an unknown and/or unknowable manner and effectively mask the contributions of their own respective input variables on downstream outcomes. In many configurations, this masking effect compounds across inference layers, and the final output, while useful as a high-order indicator, may not convey which specific input variables are driving the result or in what direction.

This problem may be exacerbated as intermediate models are changed or updated over time, augmenting or shifting behaviors of potentially all inference stages downstream thereof.

As a consequence, composite scores or metrics produced by data processing pipelines –– especially multistage data processing pipelines –– are often only leveraged as high order flags or triggers for notification purposes (e.g., system up, system down notifications) requiring further manual review or additional diligence. An example may be a status page of a distributed software service that may be used by a system architect or infrastructure administrator to determine that services are slowed, offline, or operating nominally.

More broadly, it may be appreciated that any data processing pipeline in which a downstream model consumes outputs produced by one or more upstream models introduces a layer of abstraction between the input variables of the upstream models and the output of the downstream model.

Embodiments described herein address these limitations by representing a multi-stage data processing pipeline as a directed acyclic graph in which nodes correspond to discrete inference or transformation stages of the pipeline. In this representation, directed edges between nodes define dependency relationships that encode how data propagates through the pipeline to influence final output.

More particularly, in embodiments described herein, a node of the directed acyclic graph that corresponds to an inference instance may be associated with explainability data that quantifies the relative contribution of that node's input variables to its output. The explainability data may take the form of feature importance scores, attribution values, or other metrics that the model is configured to consume.

In these embodiments, an attribution manager, operating over the graph representation of the data processing pipeline, can traverse the graph in reverse to determine dominant explainability paths through to original input variables. More specifically, explainability data associated with each node may determine that, for a given output of a given node, a particular input to that node accounted for a first percentage of explainability whereas a second input to that same node accounts for a second percentage of explainability. In this manner, in view of explainability data in respect of each node, tracing of the effects of a singular input to the output can be determined and/or apportioned.

For example, a graph representation of a data processing pipeline can receive six input variables, provided as input to two first-layer nodes. Output of the first layer nodes can be provided as dual inputs to a second layer node that, in turn, provides an output of the entire data processing pipeline. Explainability data may be associated with each of the three nodes. For example, the first layer nodes may each include explainability data in respect of each of six inputs. One of the first layer nodes (Node A) may be associated with explainability data that attributes 60% of the output of that node to the first input variable, and 8% respectively to each other of the five remaining inputs. The other first layer node (Node B) may be associated with explainability data that attributes 10% to the first input variable, 1% to the second input variable, 35% to the third input variable, 44% to the fourth input variable, 0% for the fifth input variable, and 10% to the sixth input variable. Likewise, the second-layer node (Node C), which consumes input from the output of the first layer nodes can be associated with explainability data that attributes 75% to the output of Node A and 25% to the output of Node B. In this example, an attribution manager can walk the graph data structure including Nodes C, B, and A, to determine aggregate attributions of influence of each individual input variable to the overall output of Node C. In one example, the attribution manager may multiply each sequential explainability associated with each path from the output of Node C to each respective input variable.

More specifically, for the first input variable there may be two discrete paths -- a first path from Node A to Node C and a second path from Node B to Node C. In this example, the first path, taken in reverse, attributes 75% of the output of Node C to Node A and 60% of the output of Node A to the first input. Thus, a first contribution value for the first input may be the product of 0.75 and 0.60, or 45%.

In addition, the first input variable can be attributed an influence through the second path. In this example, the second path, taken in reverse, attributes 25% to the output of Node C to Node B and 10% to the output of Node B on the first input. As with the preceding example, a product of these attributions arrives at a value of 2.5%. In some embodiments, the two attribution values for the first input variable (e.g., 45% and 2.5%) may be averaged or combined in another manner to define a final output attribution for the first value. As an example, when taking the mean of these two values, the first variable may be apportioned 23.75% influence on the output of the entire data processing pipeline.

Continuing the preceding example, the same calculation may be performed for each remaining input variable. For the second input variable, the first path through Node A yields a contribution of 0.75 multiplied by 0.08, or 6%. The second path through Node B yields a contribution of 0.25 multiplied by 0.01, or 0.25%. The mean of these two values attributes 3.125% influence on the output of the data processing pipeline to the second input variable.

Similarly, for the third input variable, the first path through Node A yields a contribution of 0.75 multiplied by 0.08, or 6%. The second path through Node B yields a contribution of 0.25 multiplied by 0.35, or 8.75%. The mean of these two values attributes 7.375% influence to the third input variable.

For the fourth input variable, the first path through Node A yields a contribution of 0.75 multiplied by 0.08, or 6%. The second path through Node B yields a contribution of 0.25 multiplied by 0.44, or 11%. The mean of these two values attributes 8.5% influence to the fourth input variable.

For the fifth input variable, the first path through Node A yields a contribution of 0.75 multiplied by 0.08, or 6%. The second path through Node B yields a contribution of 0.25 multiplied by 0.00, or 0%. The mean of these two values attributes 3.0% influence to the fifth input variable.

For the sixth input variable, the first path through Node A yields a contribution of 0.75 multiplied by 0.08, or 6%. The second path through Node B yields a contribution of 0.25 multiplied by 0.10, or 2.5%. The mean of these two values attributes 4.25% influence to the sixth input variable.

In this example, once all node paths and input contributions are determined, an attribution manager as described herein can be configured to produce a ranked ordering of input variable influence as follows: the first input variable (23.75%), the fourth input variable (8.5%), the third input variable (7.375%), the sixth input variable (4.25%), the second input variable (3.125%), and the fifth input variable (3.0%). These values may be referred to herein as "attribution values."

In some embodiments, an attribution manager as described herein may normalize the resulting attribution values such that the values sum to 1.0 (e.g., softmax or similar). Continuing the preceding example, the unnormalized attribution values for the six input variables sum to 50.0%. Dividing each attribution value by this sum produces the following normalized attributions: the first input variable (0.475), the fourth input variable (0.170), the third input variable (0.1475), the sixth input variable (0.085), the second input variable (0.0625), and the fifth input variable (0.06).

In this normalized form, the attribution values represent the proportional influence of each input variable on the output of the data processing pipeline, expressed on a scale from 0.0 to 1.0. This normalization may facilitate comparison across pipelines of different configurations and depths, and may be used to rank input variables by relative influence regardless of the number of nodes or paths in the underlying graph representation.

In other embodiments, the attribution manager may combine contribution values across multiple paths by summation rather than by averaging. In this configuration, the attribution manager may compute, for each input variable, the product of sequential explainability values along each path from the output of the pipeline to that input variable, and may thereafter sum the resulting products across all paths associated with that input variable.

Continuing the preceding example, the first input variable is associated with a first-path contribution of 0.45 and a second-path contribution of 0.025. When combined by summation, the first input variable is attributed a total influence of 0.475 on the output of the data processing pipeline. The second input variable is attributed a total influence of 0.0625, the third input variable 0.1475, the fourth input variable 0.17, the fifth input variable 0.06, and the sixth input variable 0.085.

It may be appreciated that the summation-based approach preserves the property that the total attribution across all input variables sums to 1.0 without a separate normalization operation. This property follows from the structure of the linear partition performed at each node: if the explainability values at each node sum to 1.0, and if the partitioning at each layer distributes the full importance of the upstream output among the upstream node's inputs, then the total attribution across all input variables at the input level of the graph is preserved.

By contrast, the averaging approach described above may produce attribution values that do not sum to 1.0 without further normalization, but may in some configurations reduce the influence attributed to input variables that appear across a large number of paths. The selection of a combination technique may vary from embodiment to embodiment.

In further embodiments, an attribution manager as described herein may support additional combination techniques, such as weighted summation in which longer paths are discounted relative to shorter paths, maximum-path selection in which the contribution value associated with the path of greatest magnitude is retained, or median-based aggregation. The attribution manager may be configured to apply a selected combination technique uniformly across all input variables for a given traversal, or may apply different combination techniques to different subsets of the graph.

As used herein, the term "attribution manager" generally refers to an instance of software, or a component thereof, configured to traverse a graph representation of a data processing pipeline and to determine, for each input variable of the pipeline, a quantification of that input variable's influence on the output of the pipeline. The attribution manager may operate over the directed acyclic graph by accessing explainability data associated with each node and by computing contribution values along paths through the graph. The attribution manager may be instantiated within or under the control of a data processing service, and may operate independently of the underlying models of the pipeline.

An attribution manager as described herein may operate over any node that furnishes feature-level explainability data, whether the node implements a linear regression, a logistic regression, a decision tree, a random forest, a gradient boosted ensemble, a neural network with post-hoc (or manual) attribution, or any other technique capable of producing per-feature importance metrics.

In some embodiments, explainability data associated with a given node may be generated at inference time, such that the attribution values reflect the contribution of each input variable for a specific observation or set of observations. In other embodiments, the explainability data may reflect aggregate or global feature importances computed over a training dataset, a validation dataset, or an out-of-time evaluation dataset.

More simply, in some embodiments explainability data may be static or precomputed whereas in other embodiments, explainability data may be computed at inference time. More broadly, an attribution manager may be configured to operate over either form of explainability data, and the selection of observation-level or aggregate-level attribution may depend on the analytical context.

In further embodiments, nodes within the pipeline may include not only trained machine-learning models but also deterministic transformation stages, feature engineering operations, or rule-based processing stages. A deterministic transformation stage that receives a single input and produces a single output may pass its upstream attribution through without modification. A feature engineering stage that combines multiple inputs into a derived feature may be associated with explainability data that reflects the relative contribution of each underlying input to the derived feature. In this manner, the attribution framework described herein can accommodate mixed pipelines that include both inference-based and non-inference-based processing stages.

In view of the foregoing, it may be appreciated that the attribution techniques described herein operate against nodes within the data processing pipeline that furnish feature-level explainability data.

Models that are amenable to attribution techniques described herein include, without limitation, linear regressions, logistic regressions, decision trees, random forests, gradient-boosted ensembles, and other interpretable modeling techniques that natively produce feature-level importance scores as a function of their training or inference operations. In addition, models that do not natively produce feature-level importance scores may be rendered compatible with the attribution framework by applying post-hoc explainability techniques, such as SHAP values or LIME attributions, that generate per-feature importance metrics from the model's input-output behavior.

In some embodiments, an attribution manager may be configured to evaluate whether a given node is associated with explainability data prior to initiating a traversal operation. If a node is not associated with explainability data, the attribution manager may flag that node as non-attributable/non-decomposable and may terminate the traversal at that node, retaining the node's aggregate contribution to downstream outputs. In this manner, as noted above, the attribution framework can operate over pipelines that include a mixture of explainable and non-explainable nodes, decomposing attribution through explainable nodes while preserving aggregate attribution for non-explainable nodes.

In some cases, a default influence table may be referenced by an attribution manager as described herein. The table can include attribution/influence data in respect of particular classes of input variables or particular types of input variables. For example, in a manufacturing context, temperature data may be considered, by default, as "more important" or "more influential" than sound data for a particular manufacturing station. In this example, an inference node that consumes both sound and temperature data, but does not have explainability data, may be analyzed by the attribution manager based on the default influence table. For example, the table may include default explainability for temperature-related information at 80% for a failure-prediction inference node whereas default explainability for sound-related information may be 10%. In these configurations, an attribution manager as described herein may leverage default values to determine or estimate attribution.

In still further examples, explainability information may be estimated by a generative output instance. More specifically, an LLM may be prompted with descriptive information in respect of a particular inference node and/or its respective configuration. The LLM may be prompted to generate or estimate contributions of different input variables or different input variables classes.

Further, in some examples, explainability information may relate to classes of input variables and/or types of input variables rather than particular input variables. For example, a single node may consume multiple temperature-related values, but may only be associated with explainability information in respect of all inputs that relate to temperature. In this example, temperature values as individual inputs may be evenly attributed (e.g., temperature 1 and temperature 2 may be give equal explainability for a node that consumes them both).

Further to the foregoing, in some embodiments, explainability information may encode an effect of an input variable on output of a particular node in a positive or a negative direction. More simply, explainability data as described herein can include both magnitude and direction of possible influence on downstream values.

For example, as used herein, the term "positive explainability data" generally refers to a label, identifier, or category associated with a feature whose contribution increases, improves, or otherwise positively influences the output of a given node or of the pipeline as a whole. Conversely, the term "negative explainability data" generally refers to a label, identifier, or category associated with a feature whose contribution decreases, degrades, or otherwise negatively influences the output of a given node or of the pipeline as a whole.

It may be appreciated that positive and negative may be defined differently for different applications. For example, a health score may be preferably higher whereas a disease score may be preferably lower. As such, a "positive" impact to a health score may increase the score, whereas a positive impact to a disease score may lower the score. Similarly, a credit score may be preferably higher, whereas a default risk score may be preferably lower. In this example, a positive impact on credit score may raise the score whereas a positive impact on default risk may decrease the default risk score.

In some cases, some output values may be preferably stable, rather than variable. In these examples, explainability scores may be tuned to variations in output rather than absolute value of outputs.

In some cases, higher dimensional explainability data may be determined. For example, some explainability scores may relate to rates of change, long term averages, absolute values, and so on. Many configurations are possible. For simplicity of description, the embodiments that follow reference positive explainability scores and negative explainability scores. A single input may include both a positive and a negative explainability score, or may have only a positive, negative or zero explainability score. It may be appreciated, however, that these are merely examples.

In some embodiments, positive and negative explainability codes may be defined within a model scorecard associated with a given node. The attribution manager may propagate these codes through the graph alongside the corresponding attribution values, such that the final attribution result identifies not only the magnitude of each input variable's influence, but also whether that influence is characterized as positive or negative with respect to the output. This characterization may be useful in configurations where a downstream consumer of the attribution result, whether a human operator, an automated reporting system, or a graphical user interface, benefits from understanding the direction of influence in addition to its magnitude.

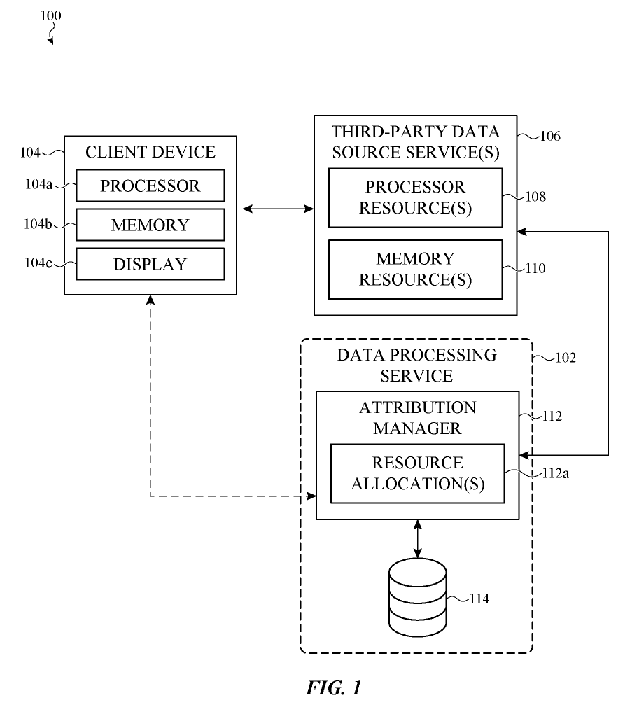

These foregoing and other embodiments are discussed below with reference to FIGS. 1-9. However, those skilled in the art will readily appreciate that the detailed description given herein with respect to these figures is for explanation only and should not be construed as limiting.

FIG. 1 depicts an example system architecture including a client device, a data processing service, an attribution manager, and associated processor and memory resources, such as described herein.

The data processing system 100 includes a data processing service 102 communicably coupled to a client device 104 and, optionally, a third-party data source service 106. The data processing system 100 can be implemented using any combination of hardware and software components. The data processing system 100 may execute operations of one or more multi-stage data processing pipelines such as those described herein.

The data processing service 102 can include one or more hardware components, software instances, or both. The data processing service 102 may represent a computing environment implementing one or more data processing pipelines configured to perform operations such as data extraction, transformation, feature generation, model inference, or result aggregation. The data processing service 102 can include and/or may be supported by one or more compute clusters, containerized functions, or serverless compute functions hosted by a service provider.

The client device 104 can be any suitable computing device configured to establish a network connection with the data processing service 102. The client device 104 can include a processor 104a, a memory 104b, and a display 104c. The client device 104 may execute a local or web-based application configured to render an interface for interaction with the data processing service 102. The client device 104 may be implemented as a laptop computer, desktop computer, smartphone, tablet, or other embedded computing platform.

The processor 104a can execute instructions stored in the memory 104b, including instructions corresponding to an instance of software instantiated to render a graphical user interface over the display 104c. The memory 104b can include non-transitory computer-readable media, such as solid-state memory, random-access memory, and persistent storage. The display 104c can be any form of graphical output device, including a touchscreen, liquid-crystal display, or light-emitting diode panel. The processor, memory, and display can cooperate to instantiate frontend application software and associated user interfaces that can be leveraged by a user of the client device 104 to engage with and/or provide information or input to the data processing service 102.

The third-party data source service 106 can represent one or more external systems configured to provide supplemental data to the data processing service 102. The third-party data source service 106 can include a processor resource 108 and a memory resource 110. The processor resource 108 can execute data aggregation or query operations to respond to data requests from the data processing service 102. The memory resource 110 can maintain datasets, indices, or derived data products consumed by the data processing service 102.

The data processing service 102 can further include an attribution manager 112 and one or more resource allocations 112a. The attribution manager 112 can be an instance of software executing within or under the control of the data processing service 102. The attribution manager 112 can be configured to traverse a graph representation of a data processing pipeline to determine and apportion influence of input variables on the output of the pipeline, as described herein. The resource allocations 112a can include processor resources, memory resources, and other computing resources allocated to the attribution manager 112 and/or to the data processing pipeline.

A data store 114 can be associated with the data processing service 102. The data store 114 may store graph representations of one or more data processing pipelines, explainability data associated with nodes of the graph, cached attribution results, model scorecards, model features, and other structured data used by the attribution manager 112. The data store 114 may be implemented as a relational database, a document store, an in-memory cache, or any combination thereof.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

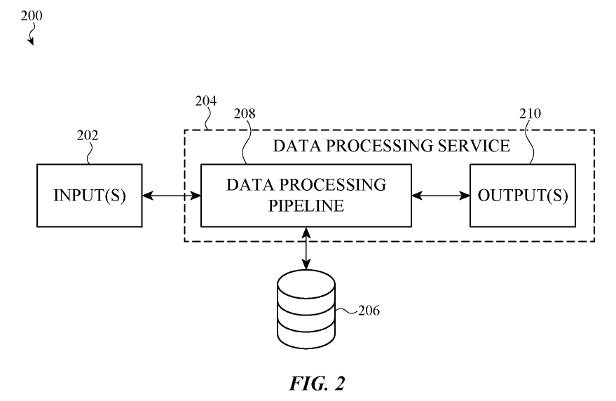

FIG. 2 depicts a functional block diagram of a data processing service including a data processing pipeline and a graph representation thereof, such as described herein.

In the illustrated embodiment, the data processing system 200 includes a data processing service 204 configured to receive one or more input values (collectively represented as the input value 202) and to generate one or more output values 210. The data processing system 200 can be implemented using any combination of hardware and software components. As with other embodiments described herein, the data processing system 200 may support attribution and partitioning operations performed by an attribution manager, such as the attribution manager 112 described with reference to FIG. 1.

An input value 202 can represent any element or atom of information received by the data processing service 204. Examples of an input value 202 include a numeric parameter, a categorical variable, a sensor reading, a document property, or any other structured or unstructured data provided as input to the data processing pipeline. The input values 202 may each influence the operation of one or more nodes within the data processing service 204.

The data processing service 204 provides a computational environment for instantiating and executing a data processing pipeline 208 and for maintaining a graph representation of the data processing pipeline 206. The data processing service 204 can include hardware compute resources, memory resources, and software instances configured to receive, transform, and output data. In some embodiments, the data processing service 204 may host multiple concurrent pipelines, each associated with a respective graph representation or a subgraph representation.

As with other embodiments described herein, a graph representation of the data processing pipeline 206 can define a directed acyclic graph in which nodes correspond to discrete processing stages of the data processing pipeline 208 and directed edges between nodes define dependency relationships that encode how data propagates through the data processing pipeline 208. The graph representation of the data processing pipeline 206 may include or be associated with explainability data for one or more nodes thereof, as described herein. In some embodiments, the graph representation of the data processing pipeline 206 may be persisted to a database, serialized in a data interchange format, or maintained in an in-memory data structure accessible to the data processing service 204.

The data processing pipeline 208 can be configured to define a series of deterministic or nondeterministic nodes, each performing a discrete operation such as data cleaning, feature generation, transformation, aggregation, or inference. The data processing pipeline 208 may receive the one or more input values 202, propagate data through the nodes defined in the graph representation of the data processing pipeline 206, and produce the one or more output values 210. In some embodiments, the data processing pipeline 208 may be implemented entirely in software, entirely in hardware, or across both.

The output value 210 represents a result generated by the data processing pipeline 208. The output value 210 can include a computed score, a classification, a prediction, a label, or any other derived value produced by the nodes of the data processing pipeline 208. When an attribution manager, such as the attribution manager 112 described with reference to FIG. 1, operates over the graph representation of the data processing pipeline 206, the attribution manager can traverse the graph representation of the data processing pipeline 206 in reverse to determine, for each of the one or more input values 202, a quantification of that input value's influence on the output value 210.

More particularly, the attribution manager can access explainability data associated with nodes of the graph representation of the data processing pipeline 206 and can compute contribution values along paths from the output value 210 back through intermediate nodes to the one or more input values 202. In this manner, the attribution manager can determine which of the one or more input values 202 contribute positively, negatively, or neutrally to the output value 210, and to what degree. The reverse traversal leverages the directed edges of the graph representation of the data processing pipeline 206 to trace dependency relationships from downstream nodes to upstream nodes, partitioning influence at each node in proportion to the explainability data associated with that node.

For example, the data processing pipeline 208 may include three nodes arranged in two layers within the graph representation of the data processing pipeline 206. A first node (Node A) and a second node (Node B) may each receive a subset of the one or more input values 202 and may each produce a respective intermediate output. A third node (Node C) may receive the intermediate outputs of the first node and the second node as input and may produce the output value 210.

In this example, explainability data associated with the third node may indicate that the intermediate output of the first node accounts for a first proportion of influence on the output value 210 and that the intermediate output of the second node accounts for a second proportion of influence on the output value 210. Similarly, explainability data associated with the first node may indicate, for each input value received by the first node, a respective proportion of influence on the intermediate output of the first node. Explainability data associated with the second node may likewise indicate, for each input value received by the second node, a respective proportion of influence on the intermediate output of the second node.

To determine the influence of a particular input value on the output value 210, the attribution manager can traverse the graph representation of the data processing pipeline 206 in reverse, beginning at the third node and proceeding through each upstream node along paths that connect the output value 210 to the particular input value. Along each path, the attribution manager can compute a contribution value by combining the explainability proportions at each node traversed. In some embodiments, this combination may take the form of a product of sequential proportions along the path. For example, if the third node attributes 70% of its output to the first node, and the first node attributes 40% of its intermediate output to a particular input value, the contribution of that input value along this path may be computed as the product of 0.70 and 0.40, yielding a path contribution of 0.28.

When a given input value is associated with multiple paths through the graph representation of the data processing pipeline 206, the attribution manager may combine contribution values across those paths. In some embodiments, the attribution manager may sum the path contributions to produce a total attribution value for that input value. In other embodiments, the attribution manager may average the path contributions or may apply a weighted combination in which shorter paths are weighted differently from longer paths. The selection of a combination technique may vary from embodiment to embodiment and may depend on the analytical context in which the attribution result is consumed.

After computing attribution values for each of the one or more input values 202, the attribution manager can produce a ranked ordering of input variable influence on the output value 210. In some embodiments, the attribution manager may normalize the resulting attribution values such that the values sum to 1.0, facilitating comparison across pipelines of different configurations and depths. In this manner, the attribution manager can distill the operation of the data processing pipeline 208, regardless of the number of intermediate nodes or layers thereof, into a set of per-input-variable influence values that quantify the positive, negative, or neutral contribution of each input value to the output value 210.

These foregoing embodiments depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

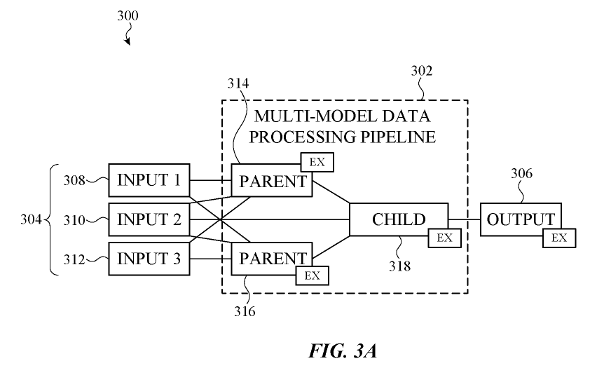

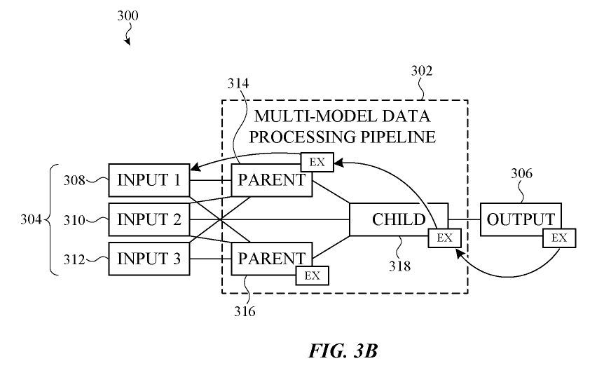

FIG. 3A depicts a multi-model data processing pipeline including a set of input variables, one or more parent nodes, a child node, and an attribution manager, such as described herein.

In particular, in this embodiment, the data processing system 300 includes a multi-model data processing pipeline 302 configured to receive a set of input variables 304 and to produce an output 306. The data processing system 300 can be implemented using any combination of hardware and software components.

The set of input variables 304 includes a first input variable 308, a second input variable 310, and a third input variable 312. In the illustrated embodiment, three input variables are shown, although this is not required of all embodiments. More broadly, the set of input variables 304 may include any number of input variables, and the number of input variables depicted in FIG. 3A is presented for simplicity of illustration.

The multi-model data processing pipeline 302 includes an attribution manager, a first parent node and a second parent node 316, and a child node 318. As illustrated, the first parent node and the second parent node 316 each receive one or more of the set of input variables 304 as input and each produce a respective intermediate output. The child node 318 receives the intermediate outputs of the first parent node and the second parent node 316 as input and produces the output 306.

More specifically, as depicted, each of the first input variable 308, the second input variable 310, and the third input variable 312 is provided as input to each of the first parent node 314 and the second parent node 316. In this configuration, the first parent node and the second parent node 316 each consume the same set of input variables 304, although this is not required of all embodiments. In other configurations, different parent nodes may receive different subsets of the set of input variables 304.

As indicated by the explainability data notation "EX" illustrated with each of the first parent node 314, the second parent node 316, and the child node 318, each node of the multi-model data processing pipeline 302 may be associated with explainability data that quantifies the relative contribution of that node's respective inputs to the output of that respective node.

The explainability data associated with each node may be stored in a common database, a data store unique to and/or dedicated to each individual node, may be stored and/or reported by the node itself or may be sorted or retrievable in another manner. In other cases, as noted above, explainability data may be determined, calculated, or approximated at runtime of each individual node.

More particularly, the first parent node 314 may be associated with explainability data indicating the relative influence of each of the first input variable 308, the second input variable 310, and the third input variable 312 on the intermediate output of the first parent node 314.

Similarly, the second parent node 316 may be associated with explainability data indicating the relative influence of each of the first input variable 308, the second input variable 310, and the third input variable 312 on the intermediate output of the second parent node 316. The child node 318 may be associated with explainability data indicating the relative influence of the intermediate output of the first parent node 314 and the intermediate output of the second parent node 316 on the output 306.

FIG. 3A depicts that the output 306 is only influenced by the output of the child node 318, but it may be appreciated that this is merely one example. In these embodiments, the explainability data associated with the output 306 may represent a final, aggregated attribution result produced by an attribution manager after traversal of the multi-model data processing pipeline 302.

An attribution manager may be instantiated over computing hardware (e.g., processor and/or memory) to traverse the graph representation of the multi-model data processing pipeline to determine attribution of explainability among the input variables. More broadly, the attribution manager can be an instance of software executing within or under the control of the data processing system 300. The attribution manager can be configured to traverse the multi-model data processing pipeline 302, leveraging explainability data associated with each node, to determine and apportion influence of the set of input variables 304 on the output 306, as described herein.

FIG. 3B depicts the multi-model data processing pipeline of FIG. 3A, illustrating an attribution traversal through parent nodes and child node, such as described herein. As depicted in FIG. 3B, the attribution manager has performed a traversal of the multi-model data processing pipeline 302 in reverse, beginning at the output 306 and proceeding through the child node 318 and each of the first parent node and the second parent node 316 to determine attribution values for each of the first input variable 308, the second input variable 310, and the third input variable 312.

In some embodiments, as noted above, the attribution traversal may trace individual paths from the output 306 through each intermediate node back to each respective input variable, computing a contribution value along each path as described with reference to FIG. 2. For example, a first path from the output 306 through the child node 318 and the first parent node to the first input variable 308 may yield a first path contribution. A second path from the output 306 through the child node 318 and the second parent node 316 to the first input variable 308 may yield a second path contribution. These path contributions may be combined, by summation, averaging, or another combination technique as described herein, to produce a total attribution value for the first input variable 308.

In FIG. 3B, an attribution manager as described herein has determined that the first input variable 308 is the most significant contributor to positive or negative changes to the output 306. As such, it may be appreciated that in many embodiments, the output 306 exhibits a degree of directionality such that a change in the output may be understood to be an improvement or a degradation, an increase or a decrease, better or worse, or the like. In this manner, when a dominant contributor (e.g., the first input variable) is identified, it may be appreciated that the attributed effect may be either positive or negative -- it may be determined that the identified variable has the most significant absolute value of possible impact to the output 306. In some embodiments the identified variable(s) may have positive impacts or negative impacts.

An influence determination may result from a single trace backward along a dominant path, or may result from a comprehensive computation of all contribution values across all paths for all input variables, followed by a ranking of the resulting attribution values. In the illustrated example, the emphasized paths in FIG. 3B represent the paths along which the first input variable 308 exerts the greatest influence on the output 306.

More broadly, after computing attribution values for each of the first input variable 308, the second input variable 310, and the third input variable 312 (or at least one thereof, by following the "most contribution" path from output to input), the attribution manager can produce a ranked ordering of input variable influence. This ranked ordering can identify which input variables contribute most positively, most negatively, or most neutrally to the output 306. In some embodiments, the attribution manager may normalize the attribution values to sum to 1.0, as described herein, to facilitate comparison across different configurations of the multi-model data processing pipeline 302.

These foregoing embodiments depicted in FIGS. 3A-3B and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

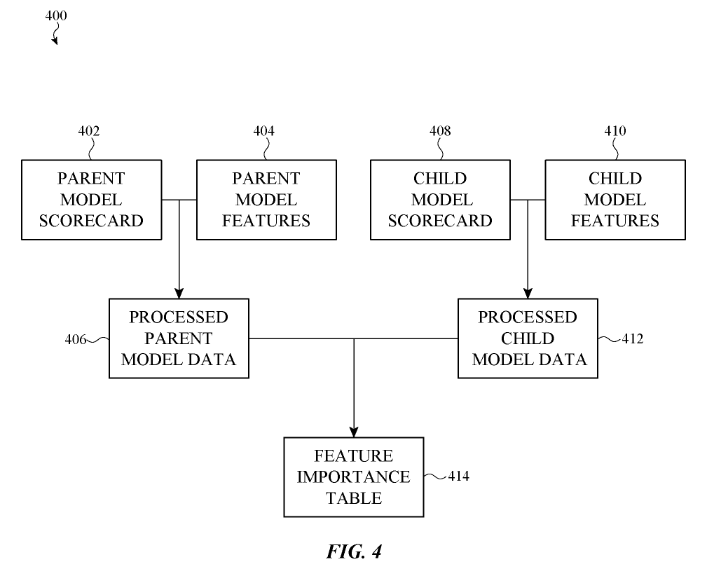

FIG. 4 depicts a data flow diagram illustrating processing of child model data and parent model data into a feature importance table, such as described herein.

A data flow diagram 400 illustrates an example process by which an attribution manager, such as the attribution manager 112 described with reference to FIG. 1 or the attribution manager described with reference to FIGS. 3A-3B, can generate a unified set of per-input-variable attribution values from data associated with child and parent nodes of a multi-model data processing pipeline. The data flow diagram 400 depicts parallel processing paths for child node data and parent node data that converge to produce a feature importance table 414.

A child model scorecard 402 can include data associating feature names with corresponding explainability codes. In some embodiments, the child model scorecard 402 may include, for each feature consumed by a child node, a feature name, a feature description, a feature value, and one or more explainability codes indicating whether that feature's contribution to the output of the child node is characterized as positive, negative, or neutral. In configurations where binned features are used, the child model scorecard 402 may additionally include feature value fields corresponding to discrete bins. In other configurations, feature value fields may be omitted.

A child model features data structure 404 can include data associating feature names with corresponding importance values. In some embodiments, the child model features data structure 404 may include, for each feature consumed by a child node, a feature name, a feature value, and a feature importance value. The feature importance value may represent a normalized measure of the influence that the respective feature exerts on the output of the child node. Feature importance values may be derived from model coefficients, permutation-based rankings, or other per-feature metrics produced by the child node during or after training.

A processed child model data structure 406 can be generated by joining the child model scorecard 402 and the child model features data structure 404 on a shared key, such as a feature name. In some embodiments, the join operation may be performed by the attribution manager or by a preprocessing routine operating under the control of a data processing service, such as the data processing service 102 described with reference to FIG. 1. The processed child model data structure 406 may associate each feature with its importance value, its explainability codes, and an indicator of whether that feature originates from a parent node or from an original input variable. This indicator can be used by downstream operations to determine which features are candidates for further decomposition through parent node explainability data.

A parent model scorecard 408 can include data structured in a manner similar to the child model scorecard 402. More specifically, the parent model scorecard 408 may include, for each feature consumed by a parent node, a feature name, a feature description, a feature value, and one or more explainability codes indicating whether that feature's contribution to the output of the parent node is characterized as positive, negative, or neutral. In some embodiments, a multi-model data processing pipeline may include multiple parent nodes, and the parent model scorecard 408 may include entries corresponding to features consumed by any or all parent nodes within the pipeline.

A parent model features data structure 410 can include data associating feature names with corresponding importance values for features consumed by one or more parent nodes. As with the child model features data structure 404, the parent model features data structure 410 may include a feature name, a feature value, and a feature importance value for each feature. In configurations where a parent node receives multiple observations per record identifier, the feature importance values within the parent model features data structure 410 may be aggregated, for example by computing a mean importance value across observations sharing a common record identifier, prior to joining with the parent model scorecard 408.

A processed parent model data structure 412 can be generated by joining the parent model scorecard 408 and the parent model features data structure 410 on a shared key, such as a feature name. In addition to associating each parent feature with its importance value and explainability codes, the processed parent model data structure 412 may include a relative contribution value computed for each parent feature. The relative contribution value may represent the proportion of that parent feature's importance relative to the total importance across all features consumed by the respective parent node. In some embodiments, the relative contribution value may be computed by dividing each parent feature's importance value by the sum of importance values for all features associated with the same parent node.

A feature importance table 414 can be generated by combining the processed child model data structure 406 and the processed parent model data structure 412. For features in the processed child model data structure 406 that originate from an original input variable rather than from a parent node, the importance value from the processed child model data structure 406 may be retained without modification. For features in the processed child model data structure 406 that originate from a parent node, the attribution manager can linearly partition the child-level importance of that feature among the parent features in proportion to their respective relative contribution values from the processed parent model data structure 412. In some embodiments, the partitioned importance for a given parent feature may be computed as a product of the child-level importance value and the relative contribution value associated with that parent feature.

In this manner, the feature importance table 414 can include a per-feature attribution value for each original input variable across the multi-model data processing pipeline, regardless of whether that input variable is consumed directly by the child node or consumed by a parent node whose output is thereafter provided to the child node. The feature importance table 414 may further include, for each feature, the explainability codes propagated from the child model scorecard 402 and the parent model scorecard 408, preserving information about the direction of influence alongside its magnitude.

For example, in a fleet management context, a child node may consume a drivetrain health metric, a safety system health metric, and an electrical system health metric to produce a composite vehicle readiness score. The drivetrain health metric may be produced by a parent node that consumes engine temperature, oil pressure, and exhaust composition data as input features. In this configuration, the child model scorecard 402 and the child model features data structure 404 may include entries for the drivetrain health metric, the safety system health metric, and the electrical system health metric.

In this example, the parent model scorecard 408 and the parent model features data structure 410 may include entries for engine temperature, oil pressure, and exhaust composition. After processing, the feature importance table 414 may include attribution values for each of engine temperature, oil pressure, exhaust composition, the safety system health metric, and the electrical system health metric, decomposing the child-level importance of the drivetrain health metric across its constituent parent features. In this manner, a fleet operator reviewing the feature importance table 414 may determine that engine temperature is the dominant contributor to a low vehicle readiness score, rather than observing only that the drivetrain health metric is the dominant child-level feature.

These foregoing embodiments depicted in FIG. 4 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

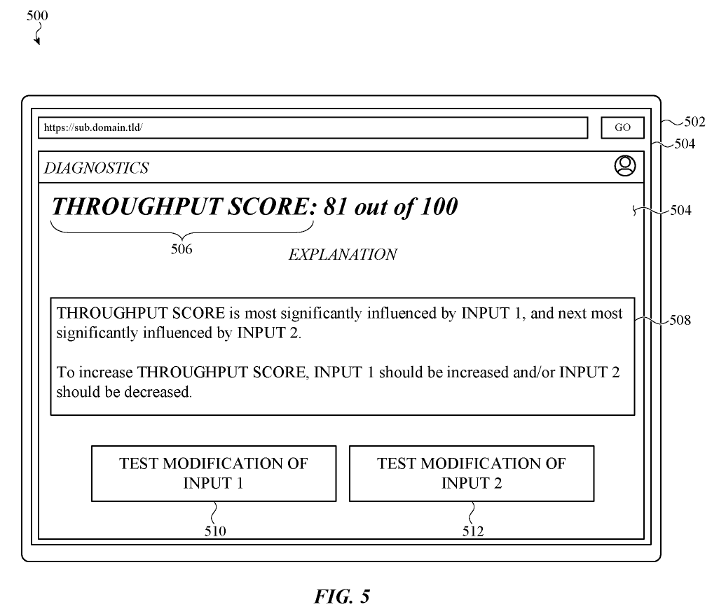

FIG. 5 depicts an example graphical user interface rendering a diagnostics environment including a computed score and feature-level influence explanations, such as described herein.

In this example embodiment, a client device 500 can render a graphical user interface on a display, the graphical user interface presenting a diagnostics environment configured to display attribution results produced by an attribution manager, such as the attribution manager 112 described with reference to FIG. 1 or the attribution manager described with reference to FIGS. 3A-3B. The client device 500 may be implemented as a laptop computer, desktop computer, tablet, smartphone, or other computing device, and may correspond to the client device 104 described with reference to FIG. 1.

A browser interface 502 can be rendered within the graphical user interface of the client device 500. The browser interface 502 may include a URL field and a navigation affordance; the diagnostics environment may be provided as a web-based application served by a backend data processing service, such as the data processing service 102 described with reference to FIG. 1. In other embodiments, the diagnostics environment may be rendered by a native application rather than a browser application, although this is not required.

A diagnostics panel 504 can be rendered within the browser interface 502. The diagnostics panel 504 provides a visual container for presenting attribution results associated with a data processing pipeline. The diagnostics panel 504 may include a header region identifying the diagnostics context, a score display region, an explanation region, and one or more interactive affordances. In some embodiments, the diagnostics panel 504 may further include user account information, navigation controls, or other interface elements.

A computed score 506 can be rendered within the diagnostics panel 504. In FIG. 5, the computed score 506 is displayed as a throughput score of 81 out of 100. The computed score 506 may represent an output value produced by a multi-model data processing pipeline, such as the output 306 described with reference to FIG. 3A or the output value 210 described with reference to FIG. 2. The computed score 506 may be rendered on any suitable scale and may represent any metric produced by a data processing pipeline as described herein, including without limitation a health metric, a readiness score, a performance evaluation, a risk assessment, or a classification result.

An explanation region 508 can be rendered within the diagnostics panel 504 below the computed score 506. The explanation region 508 can present feature-level influence explanations derived from attribution values computed by an attribution manager as described herein. In FIG. 5, the explanation region 508 identifies that the throughput score is most significantly influenced by a first input variable and next most significantly influenced by a second input variable. The explanation region 508 further indicates directional guidance, identifying that the first input variable may be increased and the second input variable may be decreased to increase the throughput score.

The content rendered within the explanation region 508 may be generated by the attribution manager or by a reporting module operating in conjunction with the attribution manager. In some embodiments, the attribution manager may produce a ranked ordering of input variable influence, as described with reference to FIGS. 2 and 3B, and a rendering service may consume that ranked ordering along with the positive and negative explainability codes associated with each input variable to generate the narrative explanation presented within the explanation region 508. In other embodiments, the content of the explanation region 508 may be generated by a generative output engine configured to consume the attribution values and explainability codes and to produce a natural language summary thereof, although this is not required of all embodiments.

A first test affordance 510 and a second test affordance 512 can be rendered within the diagnostics panel 504 below the explanation region 508. The first test affordance 510 may be configured to allow a user of the client device 500 to initiate a test modification of the first input variable, and the second test affordance 512 may be configured to allow the user to initiate a test modification of the second input variable. When selected, the first test affordance 510 or the second test affordance 512 may cause the client device 500 to transmit a request to the data processing service to re-execute the data processing pipeline with a modified value for the respective input variable and to return an updated computed score for rendering within the diagnostics panel 504.

In some embodiments, the first test affordance 510 and the second test affordance 512 may be generated dynamically based on the attribution results. More specifically, the attribution manager may determine the top-ranked input variables by influence magnitude, and the diagnostics environment may render a corresponding test affordance for each top-ranked input variable. In this manner, the number and identity of test affordances presented within the diagnostics panel 504 may vary depending on the attribution results for a given execution of the data processing pipeline.

More broadly, it may be appreciated that the diagnostics environment depicted in FIG. 5 represents one example rendering of attribution results produced by an attribution manager as described herein. In other embodiments, attribution results may be rendered as tabular data, graphical charts, ranked lists, or other visual formats. The diagnostics environment may also be configured to present attribution results for multiple output values simultaneously, or to present attribution results across different configurations of a data processing pipeline. In some embodiments, the diagnostics environment may further include affordances for selecting among different combination techniques, such as summation-based or averaging-based aggregation as described herein, to observe how the selection of a combination technique affects the rendered attribution values.

These foregoing embodiments depicted in FIG. 5 and the various alternatives thereof and variations thereto are presented, generally, for purposes of explanation, and to facilitate an understanding of various configurations and constructions of a graphical user interface, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

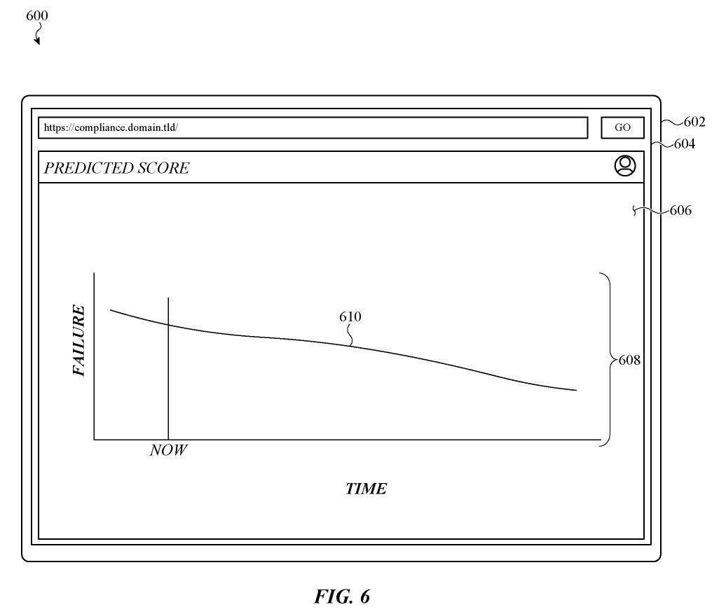

FIG. 6 depicts an example graphical user interface rendering a predicted score projection over time, such as described herein. Specifically, a client device 600 can render a graphical user interface on a display, the graphical user interface presenting a predicted score environment configured to display a time-dependent projection of an output value produced by a multi-model data processing pipeline. The client device 600 may be implemented as a laptop computer, desktop computer, tablet, smartphone, or other computing device.

A browser interface 602 can be rendered within the graphical user interface of the client device 600. The browser interface 602 may include a URL field and a navigation affordance, indicating that the predicted score environment may be provided as a web-based application served by a backend data processing service. In other embodiments, the predicted score environment may be rendered by a native application.

A predicted score panel 604 can be rendered within the browser interface 602. The predicted score panel 604 provides a visual container for presenting time-dependent projection data associated with a data processing pipeline and may include a header region, a user account region, and a graphical display region 606.

The graphical display region 606 presents a two-dimensional chart in which a horizontal axis represents time and a vertical axis represents a failure metric. A vertical marker labeled "NOW" indicates the current point in time, dividing the chart into a historical region and a projected region. A chart boundary 608 can define the rendered extent of the graphical display region 606 and the range of values represented on each axis.

A predicted score curve 610 can be rendered within the graphical display region 606, extending from the current point in time toward a future horizon. In FIG. 6, the predicted score curve 610 depicts a declining trajectory, indicating that the failure metric is projected to decrease over the rendered time period.

The predicted score curve 610 may be generated based on attribution values computed by an attribution manager as described herein. When one or more input variables that exert dominant influence on the output of a data processing pipeline are time-dependent, the attribution manager or a cooperating projection module can model anticipated changes in those variables over a future interval and can compute corresponding projected output values for each point along that interval. For example, in a fleet management context, accumulated mileage, time since last maintenance, or tire tread depth may each change predictably over time. A projection module may simulate anticipated values of those input variables at future time points, compute a corresponding projected vehicle readiness score for each time point, and render the resulting trajectory as the predicted score curve 610, allowing a fleet operator to observe when the score is projected to decline below a maintenance threshold.

In some embodiments, the graphical display region 606 may render multiple predicted score curves corresponding to different scenarios. For example, a first curve may represent a baseline projection assuming no intervention, while a second curve may represent a projection in which one or more input variables are modified at a specified future time, supporting comparative visualization of time-dependent attribution outcomes.

These foregoing embodiments depicted in FIG. 6 and the various alternatives thereof and variations thereto are presented, generally, for purposes of explanation, and to facilitate an understanding of various configurations and constructions of a graphical user interface, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

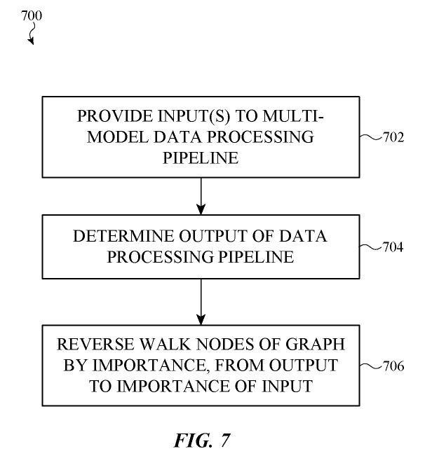

FIG. 7 is a flowchart depicting example operations of a method for providing inputs to a multi-model data processing pipeline and traversing a graph representation thereof to determine input-level importance, such as described herein.

A method 700 can be performed by a data processing service and an attribution manager operating over a graph representation of a multi-model data processing pipeline, as described herein. The method 700 includes three operations.

At operation 702, one or more input values are provided to a multi-model data processing pipeline. The input values may include numeric parameters, categorical variables, sensor readings, document properties, or any other structured or unstructured data consumed by nodes of the pipeline. The input values may be provided by a user via a client device, received from an external data source, or retrieved from a data store.

At operation 704, an output of the data processing pipeline is determined. The output may be a computed score, a classification, a label, a prediction, or any other derived value produced by propagating the input values through the nodes of the pipeline. In some embodiments, the output may be produced by a child node that consumes intermediate outputs generated by one or more parent nodes within the pipeline.

At operation 706, nodes of a graph representation of the data processing pipeline are traversed in reverse, from the output back through intermediate nodes to the input values, to determine the importance of each input value to the output. The reverse traversal may leverage explainability data associated with each node to compute contribution values along paths from the output to each respective input value. In some embodiments, contribution values may be combined across multiple paths by summation, averaging, or another combination technique to produce a per-input attribution value. The resulting attribution values may be ranked to identify which input values exert the greatest positive or negative influence on the output.

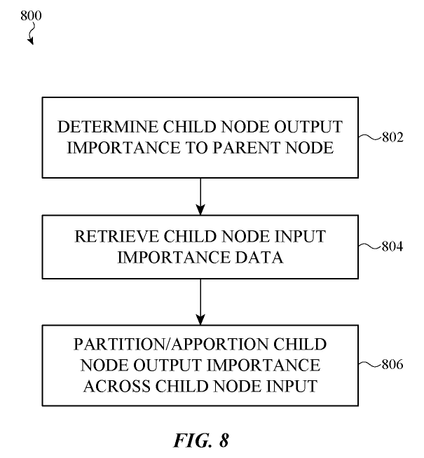

FIG. 8 is a flowchart depicting example operations of a method for determining parent node output importance and partitioning that importance across parent node inputs, such as described herein.

A method 800 can be performed by an attribution manager as part of a traversal operation within a multi-model data processing pipeline, as described herein. The method 800 includes three operations.

At operation 802, a parent node output importance to a child node is determined. The parent node output importance may represent the proportion of the child node's output that is attributable to the intermediate output of a given parent node. This proportion may be derived from explainability data associated with the child node, such as feature importance scores, attribution values, or other per-feature metrics that quantify the relative contribution of each input consumed by the child node.

At operation 804, parent node input importance data is retrieved. The parent node input importance data may include explainability data associated with the parent node that quantifies the relative contribution of each input variable consumed by the parent node to the intermediate output of that parent node. In some embodiments, when the parent node receives multiple observations per record identifier, the input importance data may be aggregated by computing a mean importance value across observations sharing a common identifier.

At operation 806, the parent node output importance determined at operation 802 is partitioned across the parent node inputs in proportion to the parent node input importance data retrieved at operation 804. For each input variable consumed by the parent node, a partitioned importance value may be computed as a product of the parent node output importance and the relative contribution of that input variable to the parent node's output. In this manner, the child-level importance attributed to a parent node's output is decomposed into per-input-variable attribution values that trace through the parent node to the original input variables.

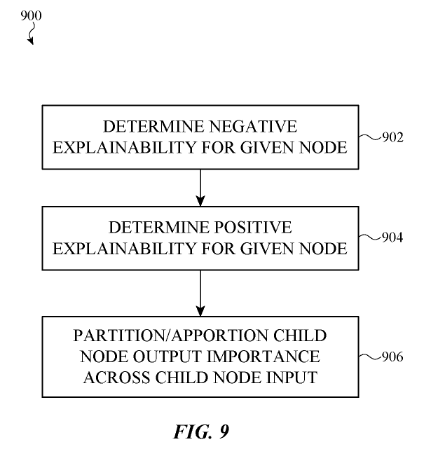

FIG. 9 is a flowchart depicting example operations of a method for determining positive and negative explainability for a given node and partitioning importance across parent node inputs, such as described herein.

A method 900 can be performed by an attribution manager when explainability data associated with a node includes directional information, as described herein. The method 900 includes three operations.

At operation 902, negative explainability for a given node is determined. Negative explainability data may identify input variables whose contributions decrease, degrade, or otherwise negatively influence the output of the node. In some embodiments, negative explainability data may be retrieved from a model scorecard associated with the node, where each input variable is associated with a negative explainability code indicating the nature or category of its negative contribution.

At operation 904, positive explainability for the given node is determined. Positive explainability data may identify input variables whose contributions increase, improve, or otherwise positively influence the output of the node. As with negative explainability data, positive explainability data may be retrieved from a model scorecard associated with the node. A single input variable may be associated with both a positive and a negative explainability code, or may be associated with only one, depending on the direction of its influence on the node's output.

At operation 906, the parent node output importance is partitioned across the parent node inputs. This partitioning may be performed in the same manner as described with respect to the method 800, with the additional characterization that each partitioned importance value retains its associated positive or negative explainability code. In this manner, the attribution manager can produce per-input-variable attribution values that quantify not only the magnitude of each input variable's influence on the output of the pipeline, but also whether that influence is characterized as positive or negative.

These foregoing embodiments depicted in FIGS. 7-9 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, as noted above, a system as described herein can be applied to determine and/or attribute influence in a number of different contexts. For example, in some embodiments, a multi-model data processing pipeline as described herein may be configured to consume bureau-reported data associated with a consumer and to produce, as output, a credit score. In this configuration, the bureau-reported data may include payment histories, account balances, account ages, credit utilization ratios, inquiry counts, and other attributes reported by one or more credit bureaus. Different subsets of the bureau-reported data may be provided as input to different child nodes within the pipeline, where each child node may be implemented as a trained neural network associated with explainability data. For example, a first child node may consume payment history and delinquency data, while a second child node may consume utilization and balance data. Each child node may produce an intermediate metric that is thereafter consumed by a parent node to produce the credit score.

An attribution manager as described herein can traverse the graph representation of such a pipeline to determine which bureau-reported input variables contribute most significantly to the credit score, and in what direction. The resulting attribution values, along with associated positive and negative explainability codes, may be used to generate feature-level explanations identifying, for example, that a high utilization ratio is the most significant negative contributor to the score, or that a long account history is the most significant positive contributor. These explanations may be rendered in a diagnostics environment such as described herein, or may be provided as structured data to a downstream reporting system configured to generate consumer-facing disclosures or internal compliance documentation.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

As used herein, the term “generative model” (and similar terms and phrases, including, but not limited to, “large language model,” “foundation model,” and “diffusion model”) may be used to refer to any machine-learning model, whether locally hosted or remotely hosted (or a combination thereof), whether implemented as a single model or as a set of cooperating sub-models, that is trained, fine-tuned, or otherwise configured to produce new data in response to an input prompt. The produced data can include, without limitation, natural-language text, executable code, images, audio, video, structured data, semi-structured data, or any combination thereof. References herein to a generative model encompass models trained using supervised, unsupervised, reinforcement, or self-supervised techniques; models generated in respect of larger parent models; and models executed on any suitable computing resource as defined above.

What is claimed is:

1. A system comprising:
a memory storing a graph representation of a data processing pipeline, the graph representation defining a directed acyclic graph in which:
a set of nodes corresponds to discrete processing stages of the data processing pipeline; and
directed edges between nodes of the set of nodes define dependency relationships that encode how data propagates through the data processing pipeline, at least a subset of the set of nodes being associated with explainability data that quantifies a relative contribution of respective inputs to a respective node to an output of the respective node; and
a processor communicably coupled to the memory and operable with the memory to:
receive a set of input values provided to the data processing pipeline;
receive an output value produced by the data processing pipeline after propagating the set of input values through the data processing pipeline;
traverse the graph representation in reverse beginning at the output value and proceeding through intermediate nodes of the set of nodes toward the set of input values by, for a given node of the set of nodes, accessing the explainability data associated with the given node to determine a proportion of influence attributable to at least one respective input of the given node on the output of the given node;
compute, for a given input value of the set of input values, a contribution value along a path from the output value through one or more intermediate nodes to the given input value, the contribution value being a product of sequential explainability proportions associated with nodes along the path;
combine contribution values across a set of paths associated with the given input value to produce an attribution value for the given input value;
generate a ranked ordering of input variable influence on the output value based on attribution values computed for the set of input values; and
cause to be rendered in a graphical user interface communicably coupled to the processor an indication of at least input variable, the at least one input variable being associated with largest absolute value of influence selected form the ranked ordering of input variable influence.

2. The system of claim 1, the processor operable with the memory to normalize the attribution values computed for the set of input values such that the attribution values sum to 1.0.

3. The system of claim 1, wherein the processor combines respective contribution values across the set of paths associated with a respective input value by summation prior to generating the ranked ordering of input value influence.

4. The system of claim 1, in which the processor combines respective contribution values across a respective set of paths associated with a respective input value by averaging.

5. The system of claim 1, in which the explainability data encodes an effect of a respective input on the output of the respective node in a positive direction or a negative direction.

6. The system of claim 1, in which the explainability data associated with at least one node of the set of nodes is generated at inference time with respect to the at least one node.

7. The system of claim 1, in which the explainability data associated with at least one node of the set of nodes is precomputed.

8. The system of claim 1, in which the processor is operable with the memory to reference an influence table to estimate attribution for a node not associated with the explainability data.

9. The system of claim 1, in which the set of nodes includes at least one deterministic transformation stage and at least one trained machine-learning model.

10. The system of claim 1, in which the output value is a composite score produced by a child node that consumes intermediate outputs generated by one or more parent nodes of the set of nodes.

11. A method for attributing influence of input variables to output values of a multi-stage data processing pipeline, the method comprising:
storing, in a memory, a graph representation of a data processing pipeline, the graph representation defining a directed acyclic graph in which:
a set of nodes corresponds to discrete processing stages of the data processing pipeline; and
directed edges between nodes of the set of nodes define dependency relationships that encode how data propagates through the data processing pipeline, at least a subset of the set of nodes being associated with explainability data that quantifies a relative contribution of respective inputs to a respective node to an output of the respective node;
receiving, by a processor communicably coupled to the memory and operable with the memory, a set of input values provided to the data processing pipeline;
receiving, by the processor, an output value produced by the data processing pipeline after propagating the set of input values through the data processing pipeline;
traversing, by the processor, the graph representation in reverse beginning at the output value and proceeding through intermediate nodes of the set of nodes toward the set of input values by, for a given node of the set of nodes, accessing the explainability data associated with the given node to determine a proportion of influence attributable to at least one respective input of the given node on the output of the given node;
computing, by the processor, for a given input value of the set of input values, a contribution value along a path from the output value through one or more intermediate nodes to the given input value, the contribution value being a product of sequential explainability proportions associated with nodes along the path;
combining, by the processor, contribution values across a set of paths associated with the given input value to produce an attribution value for the given input value;
generating, by the processor, a ranked ordering of input variable influence on the output value based on attribution values computed for the set of input values; and
causing to be rendered in a graphical user interface communicably coupled to the processor an indication of at least one input variable, the at least one input variable being associated with largest absolute value of influence selected from the ranked ordering of input variable influence.

12. The method of claim 11, comprising retaining, by the processor, for the given input value, the contribution value associated with a path of greatest magnitude among the set of paths.

13. The method of claim 11, in which the explainability data associated with at least one node of the set of nodes is estimated by a generative output instance prompted with descriptive information in respect of the respective at least one node.

14. The method of claim 11, comprising causing to be rendered in the graphical user interface a test affordance associated with the at least one input variable, the test affordance generated dynamically based on the ranked ordering of input variable influence.

15. The method of claim 11, comprising generating, by a generative output engine, a natural language summary of the attribution values for rendering within the graphical user interface.

16. A system comprising:
a memory storing a graph representation of a data processing pipeline, the graph representation defining a directed acyclic graph in which nodes correspond to discrete processing stages of the data processing pipeline and directed edges between the nodes define dependency relationships, at least a subset of the nodes being associated with explainability data; and
a processor communicably coupled to the memory and operable with the memory to:
determine a parent node output importance to a child node of the directed acyclic graph based on the explainability data associated with the child node, the parent node output importance representing a proportion of an output of the child node attributable to an intermediate output of a parent node of the directed acyclic graph;
retrieve parent node input importance data associated with the parent node, the parent node input importance data quantifying a relative contribution of input variables consumed by the parent node to the intermediate output of the parent node; and
partition the parent node output importance across the input variables consumed by the parent node in proportion to the parent node input importance data to produce, for a respective input variable, a partitioned importance value computed as a product of the parent node output importance and the relative contribution of the respective input variable to the intermediate output of the parent node.

17. The system of claim 16, in which the data processing pipeline is a device health monitoring pipeline configured to produce a composite device health score from sensor data associated with hardware subsystems of an electronic device.

18. The system of claim 16, in which the data processing pipeline is selected from the group consisting of a factory floor monitoring pipeline, a vehicle fleet management pipeline, a distributed software services monitoring pipeline, and a logistics and supply chain monitoring pipeline.

19. The system of claim 16, in which the output of the child node is selected from the group consisting of a composite score, a health metric, a label, an evaluation score, a probability, an assessment, a status, and a classification.

20. The system of claim 16, in which the data processing pipeline is a scoring pipeline in which the child node consumes intermediate metrics produced by the parent node from third-party-reported data associated with a user.
